(19) United States
(12) Patent Application Publication
(10) Pub. No.: US 2006/0050251 A1
(43) Pub. Date: Mar. 9, 2006

(54) Projection system including illumination part

(75) Inventor: Kee Tae Um, Gungnae-dong Gunpo-si (KR)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: LG Electronics Inc., Yongdungpo Seoul (KR)

(21) Appl. No.: 11/220,479

(22) Filed: Sep. 7, 2005

(30) Foreign Application Priority Data
Sep. 7, 2004 (KR) 2004-0071460

(51) Int. Cl. G03B 21/20

(52) U.S. Cl. 353/102

(57) ABSTRACT

The present invention relates to a projection system, and more particularly, to a projection system including an illumination unit. The projection system according to the present invention includes a reflection part divided into a “n” (n is a natural number) number of partial reflection parts having a first focus and a second focus, a light source part having a “n” number of light source groups, wherein each of the light source groups is located at the first focus of the partial reflection parts and outputs light, and a condenser located at the second focus of the partial reflection parts, for condensing light reflected from each of the partial reflection parts. The present invention can provide a projection system with a small size, including an illumination unit that can be miniaturized. The present invention can also provide a projection system with high efficiency, including an illumination unit that can improve efficiency.

### CROSS-REFERENCE TO RELATED APPLICATIONS

This Nonprovisional application claims priority under 35 U.S.C. § 119(a) to Korean Patent Application No. 2004-0071460 filed on Sep. 7, 2004, the entire contents of which are hereby incorporated by reference.

### BACKGROUND OF THE INVENTION

1. The Field of the Invention

The present invention relates to a projection system, and more particularly, to a projection system including an illumination unit.

2. The Relevant Technology

FIG. 1 shows the construction of a common projection system. As shown in FIG. 1, in the conventional projection system, light output from a lamp 2 (i.e., a light source) is sent to a condenser 3 using an elliptical mirror 1 (i.e., a reflection part). If the condenser 3 outputs the condensed light to a digital micromirror device (DMD) panel 7 through an illumination lens 4 and a TIR prism 6, a viewer can see images output through a projection lens 5.

Recently, the trend is to use a light emitting diode (LED) array as a light source within the projection system.

FIG. 2 shows an embodiment of an illumination unit including a conventional LED array. As shown in FIG. 2, the conventional illumination unit includes a LED array 17, a fly eye lens (FEL) 12 and an illumination lens 14. The conventional illumination unit has the FEL 12 and the illumination lens 14 disposed in the front of the LED array 17. Light output from the LED array 17 is aligned close to parallel light by the FEL 12, and is then imaged on one condenser 15. The structure following the condenser 15 is substantially the same as that of FIG. 1.

FIG. 3 shows another embodiment of an illumination unit including a conventional LED array. As shown in FIG. 3, the conventional illumination unit includes a LED array 17, a FEL 12 and an illumination lens 14 (not shown). In the conventional illumination unit, light output from the LED array 17 is aligned close to parallel light by the FEL 12 and is then imaged on condensers 15, each corresponding to each LED 10. The structure following the condensers 15 is substantially the same as that of FIG. 1.

This conventional illumination unit uses a LED having a high light emitting angle. Thus, in order for light output from the LED to be condensed on the condenser 15, the design of the FEL 12 or the illumination lens 14 is important. That is, in the case of the illumination lens 14 shown in FIG. 2, a number of illumination lenses 14 have to be disposed in series in front of the condenser 15 for condensing. Accordingly, there is a problem in that the size of the illumination unit increases. Furthermore, in the case of the condensers 15 shown in FIG. 3, there is a problem in that the size increases since a condenser 15 must be associated with each of the LEDs 10. In addition, since the LED array 17 of FIGS. 2 and 3 has a relatively large light emitting angle, there is a problem in that efficiency is low since lost light occurs. Consequently, not only is the size of the projection system increased, but the efficiency is lowered.

### BRIEF SUMMARY OF THE INVENTION

Accordingly, the present invention has been made in view of the above problems, and it is an object of the present invention to provide a projection system including an illumination unit that has a reduced sized

Another object of the present invention is to provide a projection system including an illumination unit that provides an improved operating efficiency.

To achieve the above objects, an embodiment of a projection system includes a reflection part divided into a number “n” (n is a natural number) of partial reflection parts, each having a first focus and a second focus, and a light source part having a number “n” of light source groups. In this embodiment, each of the light source groups is located at the first focus of the corresponding partial reflection part and outputs light. A condenser is located at the second focus of each partial reflection part, and condenses light reflected from each of the partial reflection parts.

Optionally, the projection system may also include a light source support part for supporting the light source groups so that each of the light source groups is fixed to the location of the first focus.

The partial reflection parts may be inclined at a predetermined gradient angle with respect to an optical axis that penetrates the center of the condenser. Also, the light source groups may be rotated at a predetermined rotation angle. Orientation of the partial reflection parts and the light source groups can thus be optimized so as to minimize light loss, and thereby improve the overall efficiency of the projection system. Moveover, the approach eliminates the need for components, and thus reduces the overall physical size of the system.

### BRIEF DESCRIPTION OF THE DRAWINGS

Further objects and advantages of the invention can be more fully understood from the following detailed description taken in conjunction with the accompanying drawings in which:

FIG. 1 shows the construction of a common projection system;

FIG. 2 shows an embodiment of an illumination unit including a conventional LED array;

FIG. 3 shows another embodiment of the illumination unit of the conventional LED array;

FIG. 4 shows the construction of a projection system including an illumination unit according to the present invention;

FIG. 5 is a front view of a reflection part according to the present invention;

FIG. 6 shows the location of a partial reflection parts according to the present invention;

FIG. 7 shows the location of a light source group according to the present invention;

FIG. 8 shows another embodiment of the illumination unit according to the present invention; and

FIG. 9 shows further another embodiment of the illumination unit according to the present invention.

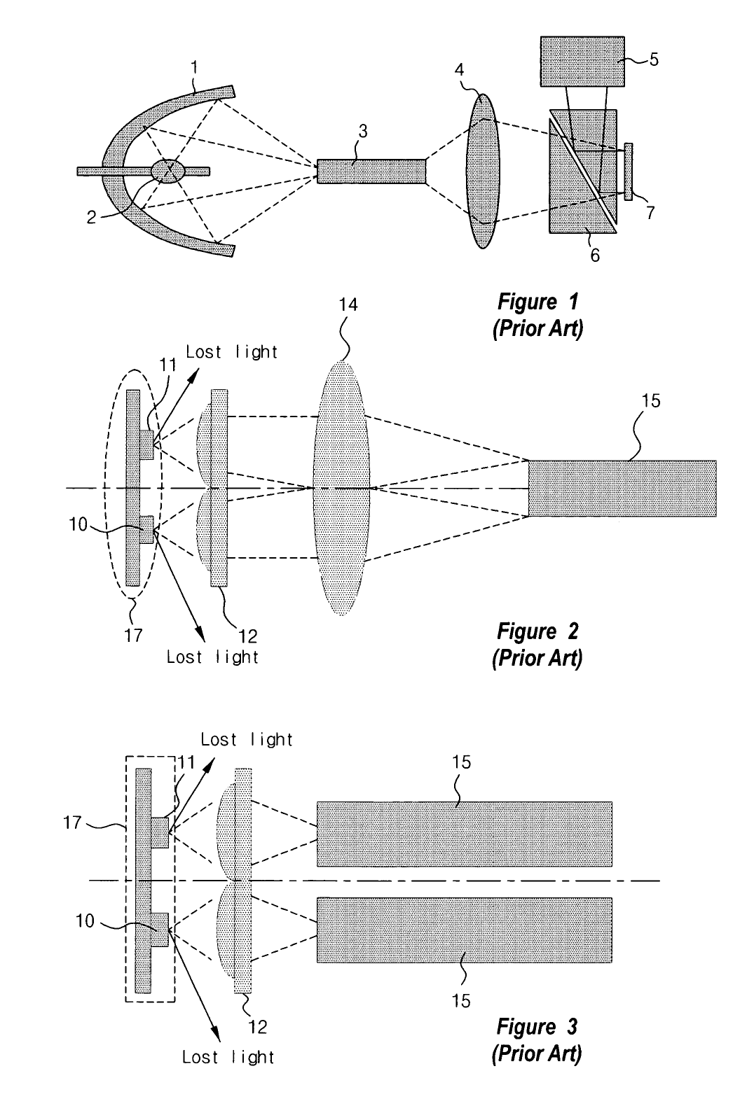

### DETAILED DESCRIPTION OF THE PREFERRED EMBODIMENTS

Aspects of the present invention will now be described in detail in connection with presently preferred embodiments with reference to the accompanying drawings.

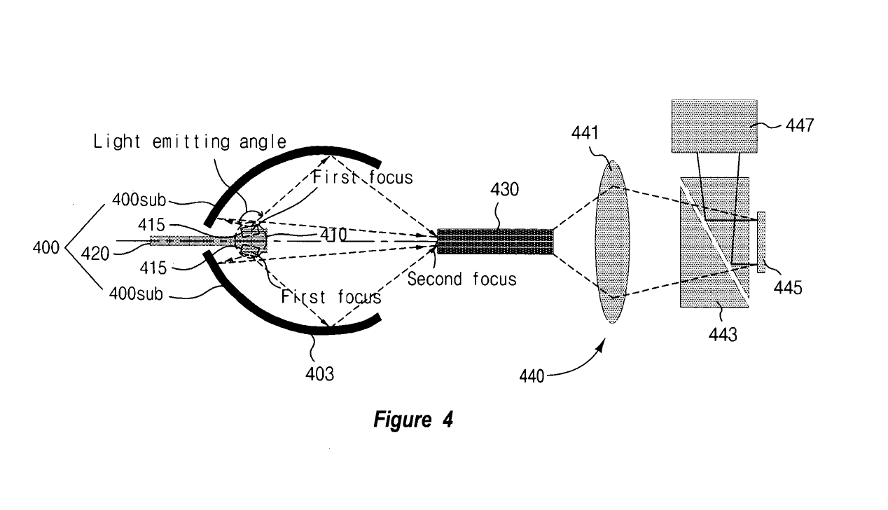

FIG. 4 shows the construction of a projection system including an illumination part according to one embodiment of the present invention. As shown in FIG. 4, the illustrated projection system includes a reflection part 400, a light source part 410, a light source support part 420, a condenser 430 and an image formation part 440.

The reflection part 400 is divided into an “n” (n is a natural number) number of partial reflection parts 400sub, each having a first focus and a second focus. In a preferred embodiment, each of the n number of partial reflection parts 400sub can be an elliptical mirror having a first focus and a second focus.

The light source part 410 includes an “in” number of light source groups 415. Each of the light source groups 415 is located at the first focus of each of the partial reflection parts 400sub and outputs light. In a preferred embodiment, the light source groups 415 can include one or more light sources. Each light source can be a LED, or any other appropriate light generator. Depending on the needs of a particular application, each of the light source groups 415 can radiate light of the same color or light of different colors.

In the illustrated embodiment, the light source support part 420 supports the light source groups 415 so that each of the light source groups 415 of the light source part 410 is fixed at a location corresponding substantially to the first focus.

The condenser 430 is located at the second focus and condenses light reflected from each of the partial reflection parts 400sub.

The image formation part 440 forms images using light output from the condenser 430. For example, if the image formation part 440 outputs light, which is output from the condenser 430, to a DMD panel 445 through an illumination lens 441 and a TIR prism 443, a viewer can see images output through a projection lens 447 of the image formation part 440. It will be appreciated that the specific structure of an image formation part may differ depending on the requirements of a projection system.

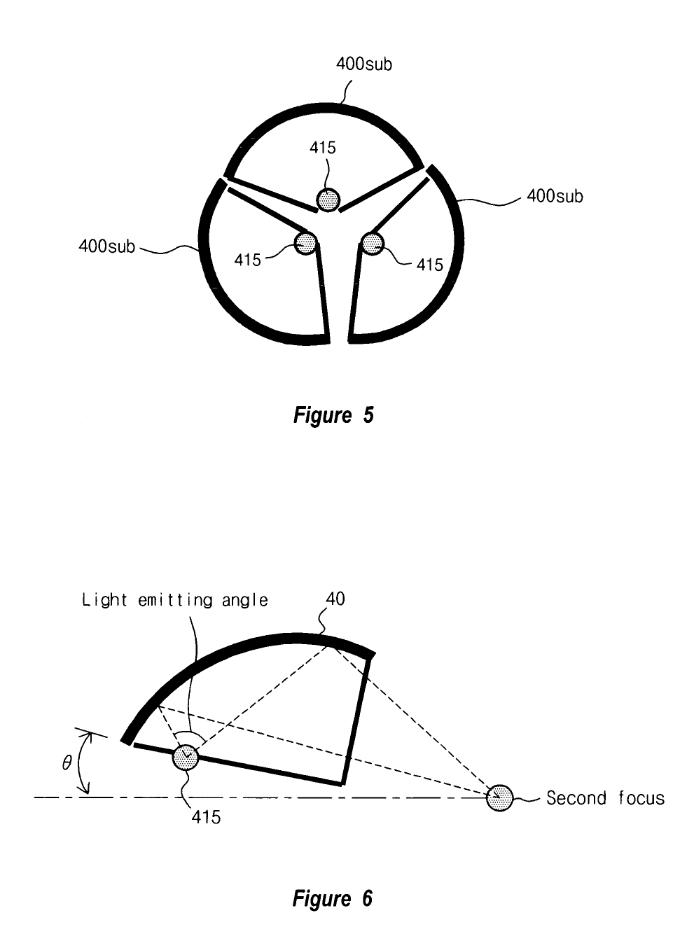

FIG. 5 is a front view of a reflection part according to an embodiment of the present invention. As shown in FIG. 5, the reflection part 400 is divided into the partial reflection parts 400sub. Furthermore, each of the partial reflection parts 400sub reflects light output from each of the light source groups 415 and outputs it to a condenser located at the second focus of each of the partial reflection parts 400sub. In the illustrated embodiment, the light source groups 415 are located at the first focus of the partial reflection parts 400sub.

As shown in FIGS. 4 and 5, the example projection system eliminates the need for the FEL 12 and the illumination lens 14 as required in the embodiment of FIG. 2, and yet still allows for the plurality of light source groups 415. As such, the overall size of the projection system is reduced. Furthermore, since a single condenser 430 is used to condense light output from the reflection part 400, there is no need for a plurality of condensers 430 as shown in FIG. 3. Again, this reduces the size of the projection system.

Moreover, the conventional projection systems shown in FIGS. 2 and 3 have lower efficiencies since light is lost to the side of the LED array 17. In the projection system of the present invention, lost light is reduced and efficiency is increased since the reflection part 400 substantially surrounds the light source groups 415. As is shown in FIG. 4, since the reflection part 400 consists of the partial reflection parts such as an elliptical mirror, lost light can be minimized although the light emitting angle of the light source groups 415 is relatively high. The light emitting angle refers to an angle in which light radiated from the light source groups 415 is reflected by the partial reflection parts and then incident on the condenser 430.

As described above, the partial reflection parts 400sub are inclined against an optical axis at a predetermined angle. Thus, the amount of light lost according to the light emitting angle of the light source groups 415 can be minimized.

FIG. 6 shows the location of the partial reflection part according to one example embodiment. As shown in FIG. 6, the partial reflection part 400sub according to the present invention is inclined against the optical axis at a gradient of 0. The optical axis refers to an axis through which the second focus penetrates. That is, it refers to an axis that penetrates the center of the condenser 430 of FIG. 4. As described above, since an optimal gradient (θ) can be set according to the light emitting angle of the light source groups 415, lost light can be minimized. In preferred embodiments, the gradient (θ) can be from approximately 0 degrees to approximately 45 degrees, although other angles may suffice.

FIG. 7 shows the location of the light source group according to an example embodiment of the present invention. As shown in FIG. 7, when the light emitting angle of the light source group 415 is φ1, lost light can be great depending on the location of the light source group 415. In order words, in the case where light radiated from the light source groups 415 whose light emitting angle is φ1 is radiated into a region \textcircled{1}, lost light is generated. In contrast, in the case where the light source groups 415 is rotated at a rotation angle of φ2 and light radiated from the light source groups 415 whose light emitting angle is φ1 and is radiated into a region \textcircled{2}, lost light does not occur. Accordingly, efficiency is increased. In presently preferred embodiments, this rotation angle (φ2) can be from 0 degrees to 90 degrees, depending on the system requirement.

The number of partial reflection parts can vary depending on the light emitting angle of the light source groups 415.

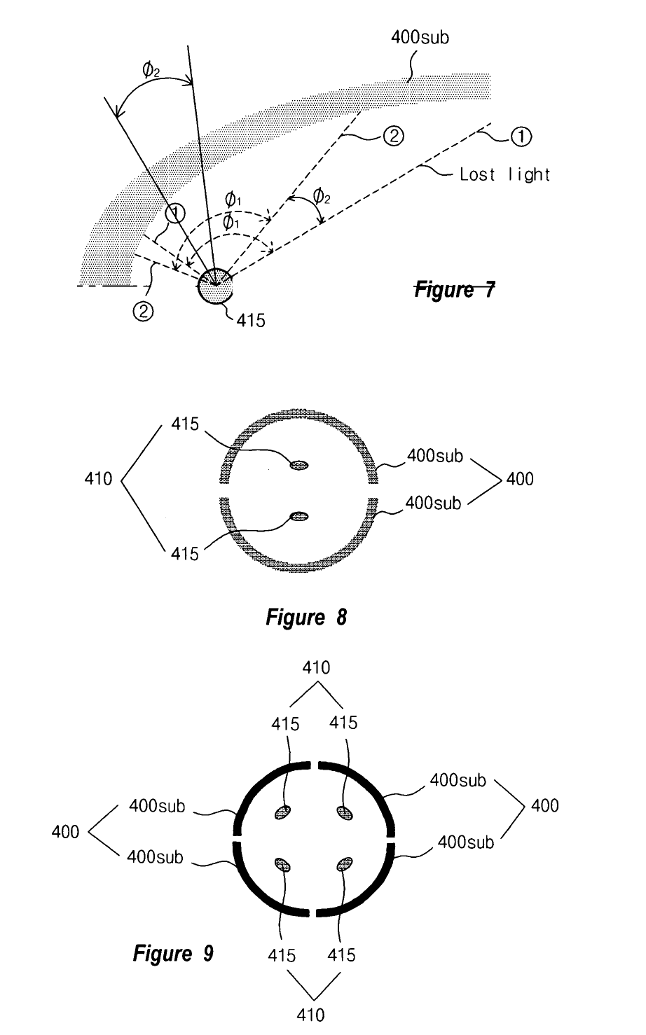

FIGS. 8 and 9 show additional embodiments of the illumination part according to the present invention.

As shown in FIG. 8, when the light emitting angle of a light source group 415 is approximately 180 degrees, the illumination unit of the present invention includes a reflection part 400 having two partial reflection parts 400sub and a light source part 410 having two light source groups 415. Each of the partial reflection parts 400sub reflects light radiated from one light source group 415.

Furthermore, as shown in FIG. 9, when the light emitting angle of a light source group 415 is approximately 90 degrees, the illumination unit of the present invention includes a reflection part 400 having four partial reflection parts 400sub and a light source part 410 having four light source groups 415. Each of the partial reflection parts 400sub reflects light radiated from one light source group 415.

For reference, the illumination unit shown in FIG. 5 corresponds to a case where the light emitting angle of the light source group 415 is approximately 120 degrees. Here, the reflection part 400 has three partial reflection parts 400sub, and the light source part 410 has three light source groups 415.

Accordingly, when the light emitting angle of the light source groups is δ, a 360/δ(=n) number of light source groups and partial reflection parts is needed.

As described above, the present invention can provide a projection system with a small size, including an illumination unit that can be miniaturized.

The present invention can provide a projection system with high efficiency, including an illumination unit that can improve efficiency.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A projection system, comprising:
a reflection part divided into a predetermined number (n) of partial reflection parts, each having a first focus and a second focus;
a light source part comprised of n light source groups, wherein each light source group is located at the first focus of a corresponding partial reflection part and outputs light; and
a condenser located at the second focus of the partial reflection parts, and oriented so as to condense light reflected from each of the partial reflection parts.

2. The projection system as claimed in claim 1, wherein each of the partial reflection parts comprise an elliptical mirror.

3. The projection system as claimed in claim 1, wherein each of the light source groups comprise one or more light sources.

4. The projection system as claimed in claim 3, wherein at least one of the light sources comprise a LED.

5. The projection system as claimed in claim 1, wherein the light source groups radiate light of different colors.

6. The projection system as claimed in claim 1, wherein the light source groups radiate light of the same color.

7. The projection system as claimed in claim 1, wherein when the light source groups have a light emitting angle (δ), and wherein n=360/δ.

8. The projection system as claimed in claim 1, further comprising a light source support part for supporting the light source groups so that each of the light source groups is substantially fixed to the location of the first focus.

9. The projection system as claimed in claim 1, wherein the partial reflection parts are inclined against an optical axis that penetrates the center of the condenser at a predetermined gradient.

10. The projection system as claimed in claim 9, wherein the gradient angle is between approximately 0 degrees to approximately 45 degrees.

11. The projection system as claimed in claim 1, wherein the light source groups are each rotated at a predetermined rotation angle.

12. The projection system as claimed in claim 11, wherein the rotation angle is between approximately 0 degrees to approximately 90 degrees.

13. The projection system as claimed in claim 1, wherein the number of partial reflection parts is between 2 and 4.

14. A projection system, comprising:
a reflection part divided into a predetermined number (n) of elliptical mirrors, each having a first focus and a second focus;
a light source part comprised of n light sources, wherein each light source is located at the first focus of a corresponding elliptical mirror and outputs light; and
a condenser located at the second focus of the elliptical mirrors, and oriented so as to condense light reflected from each of the elliptical mirrors.

15. The projection system as claimed in claim 14, wherein the light sources each comprise at least one LED.

16. The projection system as claimed in claim 14, wherein the light sources radiate light of different colors.

17. The projection system as claimed in claim 14, wherein the light sources radiate light of the same color.

18. The projection system as claimed in claim 14, wherein when the light sources have a light emitting angle (δ), and wherein n=360/δ.

19. The projection system as claimed in claim 14, wherein the elliptical mirrors are inclined against an optical axis that penetrates the center of the condenser at a predetermined gradient.

20. The projection system as claimed in claim 14, wherein the light sources are each rotated at a predetermined rotation angle.
